(19) United States
(12) Patent Application Publication
(10) Pub. No.: US 2017/0056935 A1
(43) Pub. Date: Mar. 2, 2017

(54) METHOD FOR REMOVING ALUMINUM FLUORIDE CONTAMINATION FROM SEMICONDUCTOR PROCESSING EQUIPMENT

(71) Applicant: APPLIED MATERIALS, INC., Santa Clara, CA (US)

(72) Inventors: Ramesh GOPALAN, Fremont, CA (US); Yogita PAREEK, Jaipur (IN); Jianqi WANG, Fremont, CA (US); Sio On LO, Milpitas, CA (US); Kevin A. PAPKE, San Jose, CA (US)

(21) Appl. No.: 14/839,857

(22) Filed: Aug. 28, 2015

(51) Int. Cl. B08B 3/08; B08B 3/10; B08B 3/12

(52) U.S. Cl. CPC B08B 3/08; B08B 3/12; B08B 3/102

(57) ABSTRACT

Embodiment disclosed herein generally relate to a method for removing aluminum fluoride contamination from semiconductor processing equipment. A method for cleaning semiconductor processing equipment is disclosed herein. The method includes maintaining a container of water at a temperature of between 50 degrees Celsius and 100 degrees Celsius and soaking a semiconductor processing equipment having surface contamination comprising aluminum fluoride in the water, wherein the semiconductor processing equipment is comprised of a material having a solubility directly related to the temperature of the water.

### BACKGROUND

Field

The present disclosure generally relates to a method for removing aluminum fluoride contamination from semiconductor processing equipment. Specifically, the present disclosure relates to a method for removing aluminum fluoride contamination from semiconductor processing equipment using water heated to high temperatures.

Description of the Related Art

Aluminum fluoride is a common type of contamination found on semiconductor processing equipment that use fluorine containing gas plasmas when chamber parts or substrates processed therein include aluminum or aluminum oxides and nitrides. Aluminum fluoride is not volatile and is only slightly soluble in water. Therefore, it is difficult to remove aluminum fluoride in hard to reach areas, such as gas holes and plenums.

Current methods to remove aluminum fluoride from semiconductor processing equipment use strong acids, such as hydrofluoric acid. The hydrofluoric acid, however, is known to etch the aluminum surface of the semiconductor equipment during cleaning. The etching may result in increased surface roughness, which is difficult to control, and reduces the useful lifetime of semiconductor processing equipment.

Thus, there is a need for a more effective and selective method to remove aluminum fluoride from semiconductor processing equipment.

### SUMMARY

In one embodiment, a method for cleaning semiconductor processing equipment is disclosed herein. The method includes maintaining a container of water at a temperature of between 50 degrees Celsius and 100 degrees Celsius and soaking a semiconductor processing equipment having surface contamination comprising aluminum fluoride in the water, wherein the semiconductor processing equipment is comprised of a material having a solubility directly related to the temperature of the water.

In another embodiment, a method for cleaning semiconductor processing equipment is disclosed herein. The method includes maintaining a container of water and acid at a temperature of between 50 degrees Celsius and 100 degrees Celsius, the acid having a concentration to of 5 to 10 weight percent and soaking the semiconductor processing equipment having surface contamination comprising aluminum fluoride in the water, wherein the semiconductor processing equipment is comprised of a material having a solubility directly related to the temperature of water.

In another embodiment, a method for cleaning semiconductor processing equipment is disclosed herein. The method comprising maintaining a container of water at a temperature of between 50 degrees Celsius and 100 degrees Celsius, soaking the semiconductor processing equipment in the water, the semiconductor processing equipment comprised of a material having a solubility directly related to a temperature of water; and agitating the semiconductor processing equipment while the semiconductor processing equipment is soaking.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a flow diagram of one embodiment of method for cleaning semiconductor processing equipment.

FIG. 2 illustrates a flow diagram of another embodiment of method for cleaning semiconductor processing equipment.

FIG. 3 illustrates a flow diagram of another embodiment of a method for cleaning semiconductor processing equipment.

For clarity, identical reference numerals have been used, where applicable, to designate identical elements that are common between figures. Additionally, elements of one embodiment may be advantageously adapted for utilization in other embodiments described herein.

### DETAILED DESCRIPTION

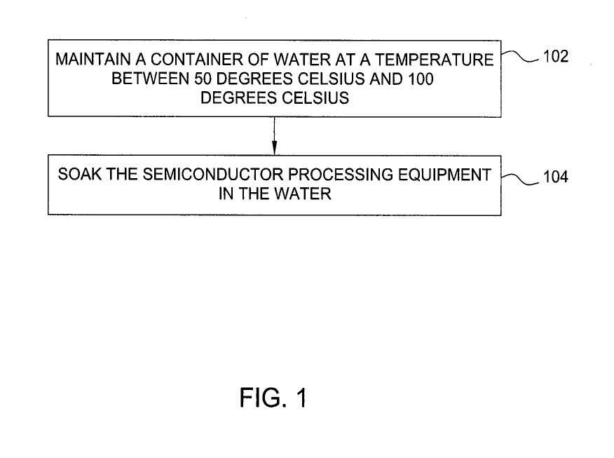

FIG. 1 illustrates a flow diagram of one embodiment of a method 100 for cleaning semiconductor processing equipment. The method is particularly useful for removing aluminum fluoride contamination from semiconductor processing equipment. As used herein, semiconductor processing equipment includes the parts and components that comprise the semiconductor processing equipment, either singularly or as part of an assembly.

The method 100 begins at block 102. At block 102, a container of water is maintaining at a temperature of between 50 degrees Celsius and 100 degrees Celsius. The container is sized to accommodate immersion of the semiconductor processing equipment to be cleaned in the water. The water may optionally include additives, such as an acid as further discussed in alternative embodiments below.

At block 104, the semiconductor processing equipment is soaked in water while maintaining the temperature between 50 degrees Celsius and 100 degrees Celsius. The semiconductor processing equipment may be formed from aluminum. Aluminum fluoride may is a contaminant that may collect on semiconductor processing equipment. The solubility of aluminum fluoride is directly related to the temperature of water. Aluminum fluoride has an initial solubility water of about 0.5 g/100 mL at 0 degrees Celsius. The solubility of aluminum fluoride rises to 1.7 g/100 mL when the water is heated 100 degrees Celsius.

While soaking the semiconductor processing equipment in the water, the water is maintained at a temperature between 50 degrees Celsius and 100 degrees Celsius. The water may be deionized water. The semiconductor processing equipment may be soaked in the water until the aluminum fluoride is substantially removed from the surface of the semiconductor processing equipment. In one embodiment, the semiconductor processing equipment may be soaked in the water for about 60 minutes. In one embodiment, the semiconductor processing equipment is soaked in the water for 10 to 45 minutes.

As discussed above, acid may optionally be added to the water in which the semiconductor processing equipment is soaked. The addition of acid further enhances the cleaning method, and can result in the near total removal of aluminum fluoride from the semiconductor processing equipment. The concentration of acid added to the water is a low concentration of acid. For example, the acid may have a concentration of 5-10% weight by water (w/w). The dilute concentration of acid ensures that the surface of the semiconductor processing equipment is not aggressively attacked and the original surface roughness and morphology is substantially preserved. In one embodiment, the acid may be nitric acid. In another embodiment, the acid may be a buffered acid (e.g. NH₄, HF, NH₄Ac, HAc, HNO₃) and the like.

The water in which the semiconducting processing equipment soaked may also be agitated. In one embodiment, ultrasonication may be used to agitate the semiconducting processing equipment. Ultrasonication is the process of applying sound energy to agitate particles in a sample at frequencies greater than 20 kHz. In another embodiment, water in which the semiconducting processing equipment soaked may mechanically agitate. For example, rotating paddles or other agitator may stir or vibrate the water while the semiconductor processing equipment is soaking. Agitating the water while semiconductor processing equipment aids is soaking helps dislodge aluminum fluoride contamination from hard to reach areas of the surface such as, small holes in a showerhead or blind plenum areas.

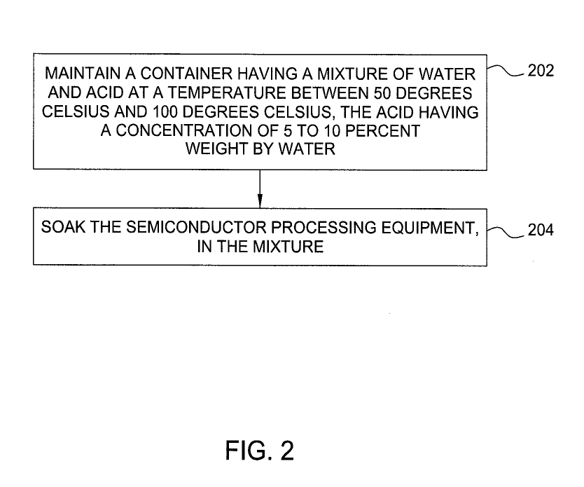

FIG. 2 illustrates another embodiment of a method 200 for cleaning aluminum fluoride contamination from semiconductor processing equipment. The method 200 begins at block 202. At block 102, a container having a mixture of water and acid is maintaining at a temperature of between 50 degrees Celsius and 100 degrees Celsius. The container is sized to accommodate immersion of the semiconductor processing equipment to be cleaned in the mixture. The acid, such as nitric acid or other suitable acid, may have a concentration of 5-10% weight by water (w/w). The dilute concentration of acid ensures that the surface of the semiconductor processing equipment is not aggressively attacked and the original surface roughness and morphology is substantially preserved. In another embodiment, the acid may be a buffered acid (e.g. NH₄, HF, NH₄Ac, HAc, HNO₃) and the like.

At block 204, the semiconductor processing equipment is soaked in the mixture to remove the aluminum fluoride contamination from the surface of the semiconductor processing equipment. The semiconductor processing equipment may be soaked until the aluminum fluoride contamination is substantially removed from the semiconductor processing equipment. While soaking, the mixture may be maintained at a temperature between 50 degrees Celsius and 100 degrees Celsius.

The semiconductor processing equipment may be formed from aluminum. Aluminum fluoride is a contaminant that may form on semiconductor processing equipment. The solubility of aluminum fluoride is directly related to the temperature of water. Aluminum fluoride has an initial solubility water of about 0.5 g/100 mL at 0 degrees Celsius. The solubility of aluminum fluoride rises to 1.7 g/100 mL when the water is heated 100 degrees Celsius.

The dilute concentration of acid ensures that the surface of the semiconductor processing equipment was not aggressively attacked and the original surface roughness and morphology was preserved. In one embodiment, the acid that may be used is nitric acid. In another embodiment, the acid may be a buffered acid (e.g. NH₄, HF, NH₄Ac, HAc, HNO₃) and the like.

The mixture may optionally be agitated while the semiconducting processing equipment is soaking in the mixture. In one embodiment, ultrasonication may be used to agitate the mixture.

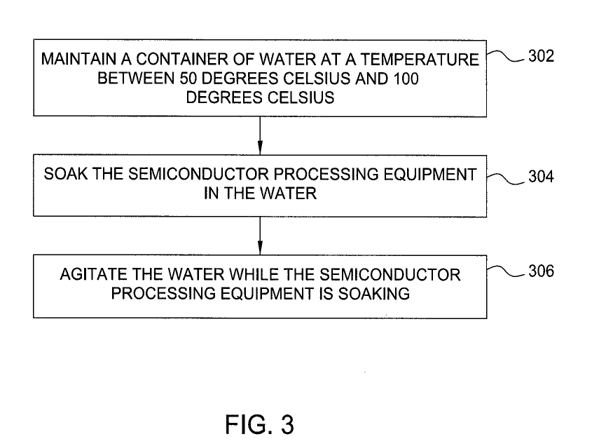

FIG. 3 illustrates another embodiment of a method 300 for cleaning semiconductor processing equipment, which is effective for removing aluminum fluoride from the surface of semiconductor processing equipment. The method 300 begins at block 302. At block 302, a container of water is maintaining at a temperature of between 50 degrees Celsius and 100 degrees Celsius. The container is sized to accommodate immersion of the semiconductor processing equipment to be cleaned in the water. The water may be deionized water. The water may optionally include additives, such as an acid as discussed above.

At block 304, the semiconductor processing equipment is soaked in water while maintaining the temperature of the water between 50 degrees Celsius and 100 degrees Celsius. The semiconductor processing equipment may be formed from a material with a solubility that is directly related to the temperature of water. For example, the semiconductor processing equipment may be formed from aluminum.

The semiconductor processing equipment may be soaked in the water until the aluminum fluoride is substantially removed from the surface of the semiconductor processing equipment. In one embodiment, the aluminum fluoride may be substantially removed from the surface of the semiconductor processing equipment by soaking the semiconductor processing equipment in the water for about 10 minutes. In one embodiment, the semiconductor processing equipment is soaked in the water for up to 60 minutes, such as between 10 to 45 minutes.

An acid may optionally be added to the water. The addition of acid may produce a near total removal of aluminum fluoride from the surface of the semiconductor processing equipment as discussed above. The concentration of acid added to the water is a low concentration of acid. For example, the acid may have a concentration of 5-10% w/w. The dilute concentration of acid ensures that the surface of the semiconductor processing equipment was not aggressively attacked and the original surface roughness and morphology was preserved. In one embodiment, the acid that may be used is nitric acid. In another embodiment, the acid may be a buffered acid (e.g. NH₄, HF, NH₄Ac, HAc, HNO₃) and the like.

At block 306, the water is agitated while the semiconductor processing equipment is soaking. In one embodiment, ultrasonication may be used to agitate the water in which the semiconducting processing equipment is soaking. In another embodiment, a mechanical agitation method may be used to agitate the water.

While the foregoing is directed to specific embodiments, other and further embodiments may be devised without departing from the basis scope thereof, and the scope thereof is determined by the claims that follow.

1. A method for cleaning semiconductor processing equipment, the method comprising:
maintaining a container consisting essentially of water at a temperature of between 50 degrees Celsius and 100 degrees Celsius; and
soaking a semiconductor processing equipment having surface contamination comprising aluminum fluoride in the water.

2. The method of claim 1, wherein the soaking comprises:
soaking the semiconductor processing equipment for less than sixty minutes.

3. The method of claim 2, wherein the soaking further comprises:
soaking the semiconductor processing equipment for between about ten and about forty-five minutes.

4. The method of claim 1, wherein the water comprises:
an acid.

5. The method of claim 4, wherein the acid has a concentration to water of five to ten percent by weight.

6. The method of claim 4, wherein the acid is nitric acid.

7. The method of claim 1, wherein the soaking further comprises:
agitating the water with ultrasound during the soaking.

8. The method of claim 1, wherein the soaking further comprises:
mechanically agitating the semiconductor processing equipment during the soaking.

9. A method for cleaning semiconductor processing equipment, the method comprising:
maintaining a container consisting essentially of water and acid at a temperature of between 50 degrees Celsius and 100 degrees Celsius, the acid having a concentration of 5 to 10 weight percent; and
soaking the semiconductor processing equipment having surface contamination comprising aluminum fluoride in the water.

10. The method of claim 9, wherein the soaking comprises:
soaking the semiconductor processing equipment for less than sixty minutes.

11. The method of claim 10, wherein the acid is a buffered acid.

12. The method of claim 9, wherein the acid is nitric acid.

13. The method of claim 9, wherein the soaking further comprises:
agitating the water with ultrasound during the soaking.

14. The method of claim 9, wherein the soaking further comprises:
mechanically agitating the semiconductor processing equipment during the soaking.

15. A method for cleaning semiconductor processing equipment, the method comprising:
maintaining a container consisting essentially of water at a temperature of between 50 degrees Celsius and 100 degrees Celsius;
soaking the semiconductor processing equipment in the water; and
agitating the semiconductor processing equipment while the semiconductor processing equipment is soaking.

16. The method of claim 15, wherein the soaking comprises:
soaking the semiconductor processing equipment for less than sixty minutes.

17. The method of claim 15, wherein the water comprises:
an acid.

18. The method of claim 17, wherein the acid has a concentration to water of five to ten percent by weight

19. The method of claim 15, wherein ultrasonication is used for agitating the semiconductor processing equipment while the semiconductor processing equipment is soaking.

20. The method of claim 15, wherein a mechanical means is used for agitating the semiconductor processing equipment while the semiconductor processing equipment is soaking.
